(19) United States
(12) Patent Application Publication
(10) Pub. No.: US 2010/0206275 A1
(43) Pub. Date: Aug. 19, 2010

(54) Exhaust gas recirculating system

(76) Inventor: Michael George Tomko, Brunswick, OH (US)

Correspondence Address: Michael G. Tomko, 1685 Stoneybrook Lane # 504, Brunswick, OH, 44212, US

(21) Appl. No.: 12/378,715

(22) Filed: Feb. 19, 2009

(51) Int. Cl. F02M 25/07

(52) U.S. Cl. 123/568.12

(57) ABSTRACT

An exhaust gas recirculation system.

### BACKGROUND AND SUMMARY OF THE INVENTION

Internal combustion engines may utilize exhaust gas recirculation systems. The composition of exhaust gas from an internal combustion engine includes water vapor (H2O), carbon dioxide (CO2) and nitrogen (N2). Exhaust gas may also include unburned hydrocarbons (CxHx), carbon monoxide (CO), nitrogen oxides (NOx), and other by products. Hydocarbons oxides can result from the reaction of nitrogen and oxygen at hight temperatures. While some combustion conditions leave some unused oxygen in the exhaust, generally exhaust gas from most internal combustion engines is substantially inert.

Exhaust gas recirculating systems may be used on all internal combustion engines to mix exhaust gas with fresh or ambient air entering the engine. By recirculating exhaust gas, unburned hydrocarbons in the exhaust stream may be utilized. Also, the addition of exhaust gas reduces the amount of oxygen entering the combustion chamber. A reduced amount of oxygen in the combustion chamber may reduce the formation of nitrogen oxides.

In the past, exhaust gas recirculating systems tap a portion of the exhaust stream from the exhaust manifold of the engine, and redirect it through an exhaust gas recirculation (EGR) valve, and then into the intake manifold. These systems are typically factory installed and not easily retrofittable by a consumer on existing engines. Further, use of the exhaust gas recirculation valve creates a relatively complex combustion system.

There remains a need in the art for an exhaust gas recirculation system that is installable on existing engine applications by a retail consumer. Alternately or in addition, there is a desire for a system that has reduced complexity. What is disclosed includes a passive exhaust gas recirculating system that does not have an exhaust gas recirculation valve and is retrofittable by a consumer on an existing engine.

### BRIEF DESCRIPTION OF THE DRAWING

FIG. 1 is a schematic including components of an exhaust recirculation system.

### DETAILED DESCRIPTION OF THE DRAWING

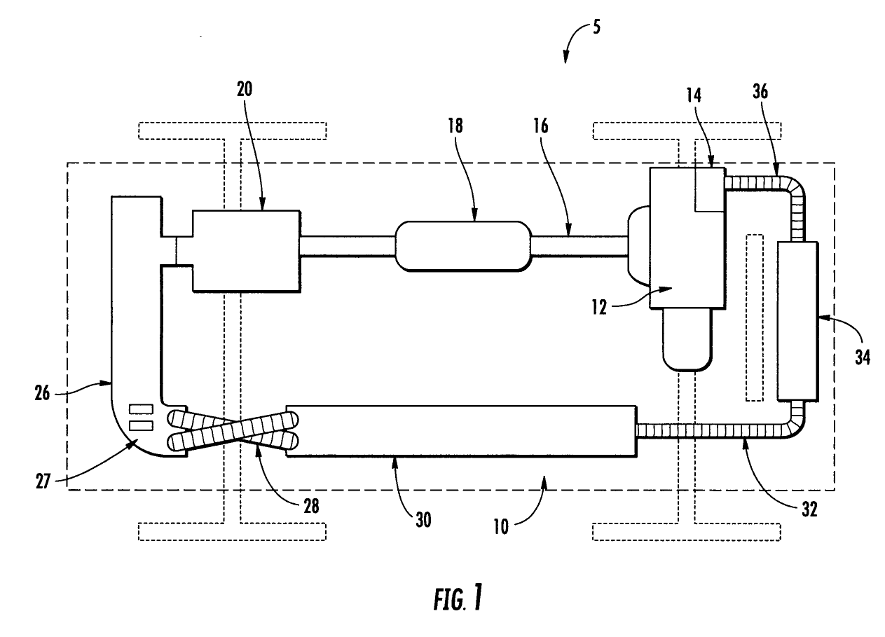

Referring now to FIG. 1, there is shown a vehicle Number 5 (hereinafter “vehicle 5”) including an exhaust gas recirculation system Number 10 (hereinafter “system 10”). Except as otherwise discussed below, the vehicle 5 may be understood to be generally conventional in the art with only the components of the vehicle 5 necessary to describe the exhaust gas recirculation system 10 being referred to.

The vehicle 5 includes an internal combustion engine 12 that cooperates with a powertrain (not shown) to drive the vehicle 5. The engine 12 has an air intake port 14 that allows air to enter the engine 12 to provide oxygen for an internal combustion process. The engine 12 has an exhaust manifold 16 that receives the exhaust gas from the internal combustion process. The exhaust gas may be between about 750° F. and 1800° F. when exiting the internal combustion engine 12.

The exhaust manifold 16 is connected to a catalytic converter 18. The catalytic converter 18 receives the exhaust gas from the exhaust manifold 16 and provides for a reaction where some of the by products of combustion may be converted from one chemical compound to another. The exhaust gas may be between about 450° F. and 1200° F. when exiting the catalytic converter 18. This works equally well on untreated exhaust on all internal combustion engines.

The catalytic converter 18 is connected to a muffler 20. The muffler 20 receives the exhaust gas from the catalytic converter 18. The muffler 20 serves to reduce the volume of noise emitted from the vehicle 5 by the engine 12 due to the internal combustion process. The exhaust gas temperature is expected to be less than 500° F. when exiting the muffler 20.

The exhaust gas recirculation system 10 includes a first, or primary, heat exchanger 26. The first heat exchanger 26 is a metal conduit, and may be made from aluminum. Alternately, the first heat exchanger 26 may be made of any material suitable for use in the undercarriage of a vehicle and capable of conducting heat. In the embodiment shown in FIG. 1, the first heat exchanger 26 is mounted under a rear bumper (not shown) of the vehicle 5. However, it must be understood the first heat exchanger 26 may be mounted in any suitable location.

The first heat exchanger 26 has a rectangular shaped cross-section having a cross-sectional area with an average diameter of 2.5 inches. Although, the first heat exchanger 26 may have any suitable cross-section, such as circular or oval, with any suitable cross-sectional area as desired for the flow of the exhaust gas. The dimensions of the first heat exchanger 26 may be varied as to the application of the exhaust gas recirculation system 10 to a particular make and model of a vehicle. For example, the size and flow potential of the first heat exchanger 26 may be chosen based upon the dimensions of the vehicle 5 and/or upon the displacement size and/or number of cylinders of the engine 12, or any other suitable criteria.

The first heat exchanger 26 may be a tube heat exchanger wherein the exhaust gas passes through the tube, and heat transfers to cooling air on the outside of the tube by convection. Cooling air may be provided by ambient air, which may form an airflow when the vehicle is moving. To further assist in the dissipation of heat the first heat exchanger 26 may include an optional external fan (not shown) to move air about the first heat exchanger 26. Optionally, the first heat exchanger 26 may be a modified air-conditioning condenser or employ multiple air-conditioning condensers.

The first heat exchanger 26 is may be wrapped with a screen material, which may be made of aluminum, to assist in the dissipation of heat. Alternately or in addition, the first heat exchanger 26 may include fins, corrugations, or other features providing an increased surface area. The first heat exchanger 26 may also include the screen material, or screening, in the interior. The interior screening may be oriented in any suitable manner, such as longitudinally, in a direction parallel to the flow of the exhaust gas, or laterally, in a direction perpendicular to the flow of the exhaust gas exam, or in any other suitable orientation. For further example, the interior screening may be disposed within the first heat exchanger 26 in a folded accordion type arrangement. The exhaust gas is expected to be between about 300 ° F. and 150° F. when exiting the first heat exchanger 26.

Optionally, the first heat exchanger 26 includes vents 27, although such are not required. The vents 27 are formed through the exterior of the first heat exchanger 26 to provide for a predetermined amount of fresh or ambient air to enter the exhaust gas recirculation system 10.

At least one connection tube 28, two shown, is connected to the first heat exchanger 26, and receives the exhaust gas therefrom. The tubes 28 may be formed from 1 inch flexible aluminum tubing. However, it must be understood that the tubes 28 may be formed from any other metals or material in other size, such as to provide for passage of the exhaust gas. In the embodiment shown in FIG. 1 the tubes 28 are formed from a spiral wound strip of metal with overlapping edges. It is contemplated that the tubes 28 may be flexed to open gaps between the overlapping edges to allow a predetermined amount of fresh air to enter the system 10. As illustrated, the tubes 28 are arranged to cross over a rear axle of the vehicle 5, but such is not required. In one embodiment, the tubes 28 are configured to disrupt pulsations in exhaust flow at an idling state.

A second, or secondary, heat exchanger 30, similar to the first heat exchanger 26 is connected to the tubes 28, and receives the exhaust gas therefrom. The second heat exchanger 30 is metal conduit, made from aluminum. Although, the second heat exchanger 30 may be made of any material suitable for use in the undercarriage of a vehicle and capable of conduction heat. In the embodiment shown in FIG. 1, the second heat exchanger 30 is mounted behind the rocker panel (not shown) and under the floorboards (not shown) of the vehicle 5. However, it must be understood that the second heat exchanger 30 may be mounted in any suitable location.

The second heat exchanger 30 may be a tube heat exchanger wherein the exhaust gas passes through the tube, and heat transfers to cooling air on the outside of the tube by convection. Cooling air may be provided by ambient air, which may form an airflow when the vehicle is moving. To further assist in the dissipation of heat the second heat exchanger 30 may include an optional external fan (not shown) to move air about the second heat exchanger 30. Optionally, the second heat exchanger 30 may also include an air-conditioning connection to the preexisting air-conditioner included with the vehicle 5 to further cool the exhaust.

The second heat exchanger 30 may have a rectangular shaped cross-section having a cross-sectional area with an average diameter of 2.5 inches. Alternately, the second heat exchanger 30 may have any suitable cross-section, such as circular or oval, with any suitable cross-sectional area as desired for the flow of the exhaust gas. Alternately or in addition, the first heat exchanger 26 may include fins, corrugations, or other features providing an increased surface area. The dimensions of the second heat exchanger 30 may be varied as to the application of the exhaust gas recirculation system 10 to a particular make and model of a vehicle. For example, the size and flow potential of the second heat exchanger 30 may be chosen based upon the dimensions of the vehicle 5 and/or upon the displacement size and/or number of cylinders of the engine 12, or any other suitable criteria and adjustable depending on the make and model of the vehicle 5. In one embodiment, the second heat exchanger 30 is longer, therefore has more surface area, than first heat exchanger 26, and thus provides greater potential for cooling of the exhaust gas after passing though the tubes 28.

The second heat exchanger 30 is wrapped with screening, made of aluminum, to assist in the dissipation of heat. The second heat exchanger 30 also includes aluminum screening in the interior. The interior aluminum screening may be oriented in any suitable manner, such as longitudinally, in a direction parallel to the flow of the exhaust gas, or laterally, in a direction perpendicular to the flow of the exhaust gas, or in any other suitable orientation. For further example, the interior screening may be disposed within the second heat exchanger 30 in a folded accordion type arrangement. The temperature of the exhaust gas exiting the second heat exchanger 30 for a convection system depends on the ambient air temperature, but is typically less than about 120° F., and may be between about 70° F. and 100° F.

A first hose 32 is provided to connect the second heat exchanger 30 to a stabilizer tank 34. The first hose may be a 1.5 inch flex hose, made of plastic, and may be ribbed, or may be made rubber or any other material in any size suitable to provide for the passage of the exhaust gas from the second heat exchanger 30 to the stabilizer tank 34. Optionally, an inline charcoal filter or equivalent (not shown) and an air pump (not shown) may be required.

The stabilizer tank 34 may be metal, such as aluminum, or may be plastic or other material suitable to contain the exhaust gas. The size and construction of the stabilizer tank 34 may be varied depending on specifications of the vehicle 5 as desired. The stabilizer tank 34 is mounted in a location where ambient air can circulate about the tank to thermally regulate the tank. Optionally, the stabilizer tank 34 can be a modified air-conditioning condenser. The stabilizer tank may reduce engine pulsing and surging at idling.

A second hose 36 is connected to the stabilizer tank 34 and the air intake port 14. The second hose may be a 1.25 inch flex hose, and may be made of plastic. The second hose 36 may be a ribbed hose, or may be made of rubber or any other material in any size suitable for providing for the passage of the exhaust gas from the stabilizer tank 24 to the air intake port 14.

It is contemplated that the system 10 may include a condensation control device, such as a steam trap, air/water filter, a weep system, for example including a wick and drain, or any other device or devices suitable to remove condensate from the system 10. It is further contemplated that the system 10 may include any number of safety devices such as a manual bypass device to allow ambient air to enter the intake port 14 without any significant amount of exhaust gas. Additionally, the system 10 may include a number of sensors or detectors, such as a carbon monoxide detector or temperature senor or the like.

In one operation, at least a portion of the exhaust gas from the engine enters the first heat exchange 26 from the muffler 20 and cools to at least some extent. The exhaust gas then flows through the tubes 28, which may disrupt the flow as desired. A predetermined amount of ambient air may be introduced in to the system 10 through either the vents 27 in the first heat exchanger 26 or through gaps in overlapping edges of the tubes 28. Then, the exhaust gas flows through the second heat exchanger 30 and is further cooled, for example, to a temperature near the ambient air temperature. The second heat exchanger 30 is in communication with the air intake port 14 through the stabilizer tank 34. The stabilizer tank may act as a buffer for the exhaust gas before returning to the engine 12 through the air intake port 14. In this manner of operation, the engine draws air into the intake port 14, and thereby drawing cooled exhaust gas from the second heat exchanger 30 through the stabilizer tank 34.

It is contemplated that the aspiration of the engine will draw a predetermined desired portion of the exhaust gas from the second hose 36 into the air intake port 14. This portion of exhaust gas from the second hose 36 may be all or some fraction less than all of the air drawn into the air intake port 14. In the case where the portion from the second hose 36 is less than all, the remainder of the draw may be from the ambient environment. The flow of exhaust gas into the intake port 14, or draw, maintains a flow of exhaust gas through the recirculating system. In the case where less than all of the exhaust gas is drawn into the air intake port 14, it is contemplated that the remainder may be discharged into the environment.

While the principle and mode of operation of this invention have been explained and illustrated with regards to a particular embodiment(s), it must be understood, however, that this invention may be practiced otherwise than as specifically explained and illustrated without departing from its spirit or scope.

What is claimed is:

1. An exhaust gas recirculation system comprising:
A heat exchanger adapted to be connected to an exhaust pipe of a vehicle downstream of a muffler of the vehicle.

2. An exhaust gas recirculation system comprising:
At least one connection tube adapted for passage of a volume of exhaust gas from an engine of a vehicle; and
a stabilizer tank for receiving the volume of exhaust gas from the connection tube.

3. An exhaust gas recirculation system kit comprising:
a heat exchanger configured to be connected to an end of an exhaust pipe of vehicle downstream of a muffler of the vehicle.

4. A passive exhaust gas recirculation system comprising:
At least one of a vented heat exchanger and a connection tube;
Wherein a predetermined amount of fresh air is permitted to enter the system through the one of the vented heat exchanger and the connection tube.
